(19) United States
(12) Patent Application Publication
(10) Pub. No.: US 2014/0360672 A1
(43) Pub. Date: Dec. 11, 2014

(54) Multi-Piece Sealing Sleeve

(71) Applicant: Davian Enterprises, LLC, Greenback, TN (US)

(72) Inventors: Robert L. Marcus, JR., Knoxville, TN (US); David Huffstetler, Maryville, TN (US)

(21) Appl. No.: 14/469,861

(22) Filed: Aug. 27, 2014

Related U.S. Application Data
(63) Continuation of application No. 13/176,396, filed on Jul. 5, 2011.

(51) Int. Cl. B29D 30/26

(52) U.S. Cl. CPC B29D 30/26; B29K 2995/0074
USPC 156/414

(57) ABSTRACT

A multi-piece sealing sleeve is disclosed. The multi-piece sealing sleeve includes annular first and second layers of a substantially air-impermeable material. The first layer has an inner edge sized to surround a base portion of the tire shaping drum. An outer edge of the first layer extends radially outwardly to overlie at least a portion of a radially expandable and collapsible structure defined by the tire shaping drum. The second layer is sized to overlie and establish sealing engagement with at least a portion of the first layer and a bead seat defined by the radially expandable and collapsible structure of the tire shaping drum. The first and second layers cooperate to establish a substantially airtight seal between the tire shaping drum base portion and the bead seat.

### CROSS-REFERENCE TO RELATED APPLICATIONS

This application is a continuation of prior U.S. patent application Ser. No. 13/176,396, filed Jul. 5, 2011.

### STATEMENT REGARDING FEDERALLY-SPONSORED RESEARCH OR DEVELOPMENT

Not Applicable

### BACKGROUND OF THE INVENTION

1. Field of Invention

This invention pertains to apparatus useful in the manufacture of tires. More particularly, this invention pertains to a multi-piece sealing sleeve useful with a tire shaping drum to facilitate building and shaping of a tire carcass of the type used in the manufacture of radial automotive tires.

2. Description of the Related Art

Tires, such as for example radial automotive tires, of the type having an inner liner, a plurality of body plies, sidewalls, and a plurality of beads disposed proximate an inner circumference of the tire, are known in the art. It is understood generally that in traditional tire manufacture, following initial preparation of various components to be used, a generally cylindrical tire carcass is built through a process of assembling various components of a tire onto one or more tire building drums. Such tire carcasses normally include tire components such as multiple plies of tire bands, yarns, and one or more annular reinforcing tire beads at opposite ends of the tire bands. Thereafter, the tire carcass is expanded to a toroidal shape with the plies of tire bands forming an outer circumference of the toroid and the tire beads forming inner circumferences of the toroid. Often additional material is added to the tire carcass to form an uncured or “green” tire. The green tire is then formed into a desired finished geometry and cured to allow the tire to retain the finished geometry, thereby completing manufacture of the tire.

One apparatus and method useful in expanding a tire carcass to a toroidal shape is a tire shaping drum of the type discussed in U.S. Pat. No. 4,325,764, issued to Appleby et al. (hereinafter “the '764 patent”). In the '764 patent, a tire carcass is placed over a tire shaping drum having a pair of segmented, radially expandable annular support structures, each support structure defining a radially expandable bead seat for establishing a firm frictional connection between the support structure and a reinforcing bead of the tire carcass. The annular support structures defining the bead seats are typically adjustably repositionable proximate one another along an axial dimension of the tire shaping drum to assist both in mating the bead seats to the reinforcing beads of the tire carcass and in shaping the tire carcass to a toroidal shape. The tire shaping drum is adapted to allow injection of air or other fluid between the tire carcass and a portion of the tire shaping drum between the bead seats to allow the tire carcass to be expanded to a toroidal shape. An annular sealing sleeve of a resilient material, such as rubber, polymer, or the like, is provided along portions of the annular support structures between each radially expandable bead seat and an inner portion of the tire shaping drum to form a substantially airtight engagement between the tire carcass and the portion of the tire shaping drum interior of the bead seats.

Through repeated use of a tire shaping drum of the type having one or more annular sealing sleeves as described above, frictional contact between the reinforcing bead of the tire carcass and the annular sealing sleeve, as well as elastic deformation of the annular sealing sleeve through repeated expansion and contraction of the annular support structures, results in eventual wear and degradation of the resilient material forming the annular sealing sleeve. More specifically, it is noted that such wear and degradation often occurs most prominently along portions of the annular sealing sleeve proximate the bead seat portion of the annular support structure of the tire shaping drum. Such wear and degradation, if allowed to proceed indefinitely, eventually results in rupture, tearing, or surface deformation of the annular sealing sleeve, thereby resulting in loss of the ability of the annular sealing sleeve to maintain airtight engagement between the tire carcass and the portion of the tire shaping drum interior of the bead seats. Accordingly, it is often necessary to periodically replace the annular sealing sleeves on the tire shaping drum.

Replacement of an annular sealing sleeve on a tire shaping drum typically requires expansion of the replacement annular sealing sleeve radially outwardly to allow the replacement sleeve to fit over a corresponding annular support structure of the tire shaping drum. This expansion is typically accomplished through use of an annular frame having a plurality of inwardly facing hooks which are each extendable and retractable between a collapsed position and an expanded position. The hooks are adapted to be selectively extended inwardly of the annular frame to engage the replacement sleeve and selectively retracted toward the annular frame to stretch the replacement sleeve to an expanded geometry. The annular frame carrying the expanded annular sealing sleeve can then be positioned with respect to the tire shaping drum to surround the bead seat and inner portions of the annular support structure. Thereafter, the hooks of the annular frame can be selectively extended inwardly of the annular frame and disengaged from the annular sealing sleeve to allow the annular sealing sleeve to contract to fit along the bead seat and inner portions of the annular support structure.

The above-discussed process for replacement of an annular sealing sleeve on a tire shaping drum is often both cumbersome and time consuming, as it typically requires individual selective extension and retraction of the various hooks of the annular frame. Furthermore, operation of the above-discussed frame for stretching the replacement annular sealing sleeve can pose a safety risk in the event an annular sealing sleeve becomes disengaged from the frame while expanded on the frame. More specifically, if inadvertently released from the frame, the annular sealing sleeve may quickly contract to its unstretched configuration potentially striking and harming the user of the frame or other surroundings. Accordingly, a multi-piece sealing sleeve for a tire shaping drum which is configured to allow quick, safe, and convenient replacement of worn portions of the sleeve is desirable.

### BRIEF SUMMARY OF THE INVENTION

A multi-piece sealing sleeve for use with a tire shaping drum is disclosed herein. A typical tire shaping drum can include a support structure having a base portion and an annular, radially expandable and collapsible structure defining a bead seat. The bead seat can be radially expandable to engage a surrounding bead portion of a tire carcass. In one embodiment, the multi-piece sealing sleeve comprises an annular first layer of substantially air-impermeable material having an inner edge sized to surround the tire shaping drum base portion and an outer edge extending radially outwardly to overlie at least a portion of the radially expandable and collapsible structure of the tire shaping drum. An annular second layer of substantially air-impermeable material is provided and sized to overlie and establish sealing engagement with at least a portion of the annular first layer and the bead seat portion of the tire shaping drum. The first and second layers thus cooperate to establish a substantially airtight seal between the tire shaping drum base portion and the bead seat.

In several embodiments, a fastener is provided for securing at least one of the first and second layers along the radially expandable and collapsible structure of the tire shaping drum. In one embodiment, the fastener is defined by at least one annular band sized to circumferentially surround and exert compression along at least a portion of at least one of said first and second layers. In one application of the embodiment, the fastener is configured to fit within a fastening groove defined by the radially expandable and collapsible structure of the tire shaping drum.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 is an exploded view showing one embodiment of a multi-piece sealing sleeve for a tire shaping drum of the present invention, along with an annular support structure portion of a tire shaping drum;

FIG. 2 is a perspective view of the multi-piece sealing sleeve for a tire shaping drum of FIG. 1, shown positioned on the annular support structure of FIG. 1;

FIG. 3 is a cross-sectional view of the multi-piece sealing sleeve for a tire shaping drum and annular support structure of FIG. 2, showing a close-up view of the multi-piece sealing sleeve for a tire shaping drum with the annular support structure in a collapsed position;

FIG. 4 is a cross-sectional view of the multi-piece sealing sleeve for a tire shaping drum and annular support structure of FIG. 2, showing a close-up view of the multi-piece sealing sleeve for a tire shaping drum with the annular support structure in an expanded position;

FIG. 5 is a cross-sectional view of another embodiment of a multi-piece sealing sleeve for a tire shaping drum, together with an annular support structure, and also showing a close-up view of the multi-piece sealing sleeve for a tire shaping drum with the annular support structure in a collapsed position; and

FIG. 6 is a cross-sectional view of another embodiment of a multi-piece sealing sleeve for a tire shaping drum, together with an annular support structure, and also showing a close-up view of the multi-piece sealing sleeve for a tire shaping drum with the annular support structure in a collapsed position.

### DETAILED DESCRIPTION OF THE INVENTION

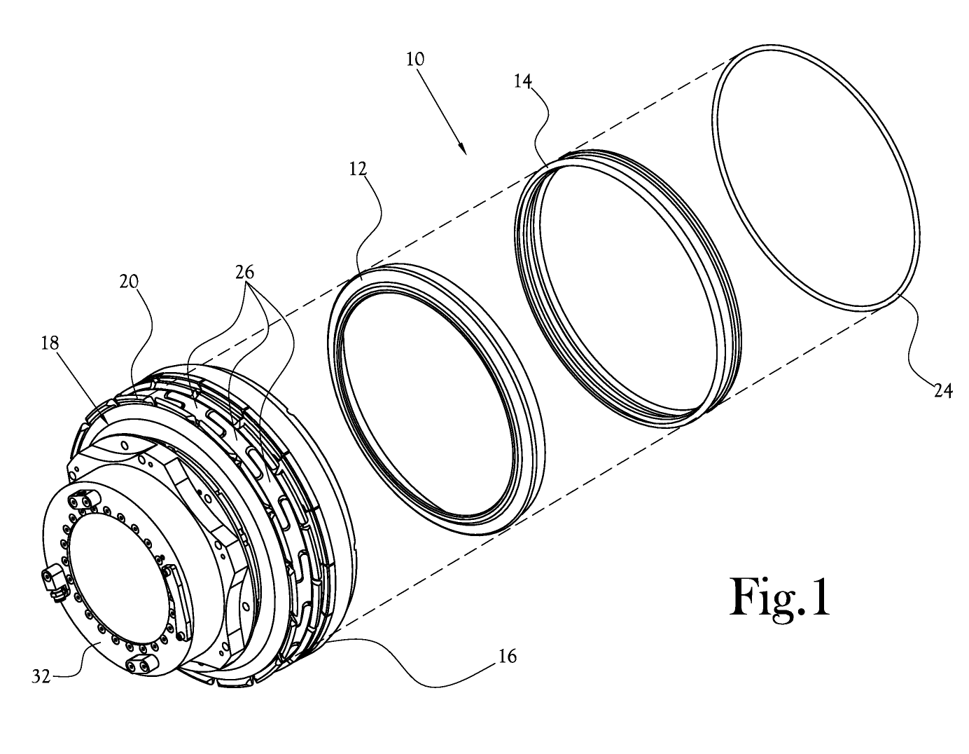

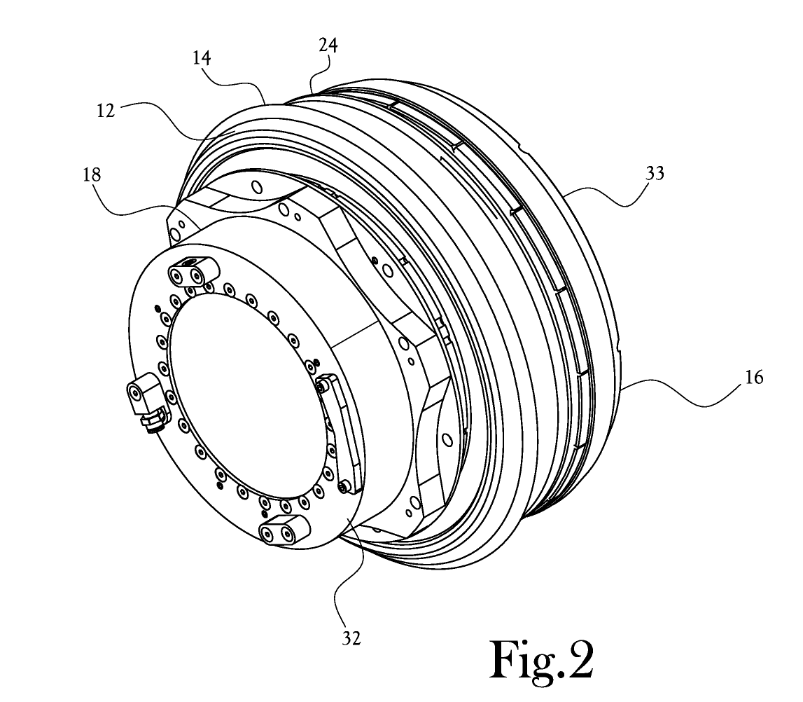

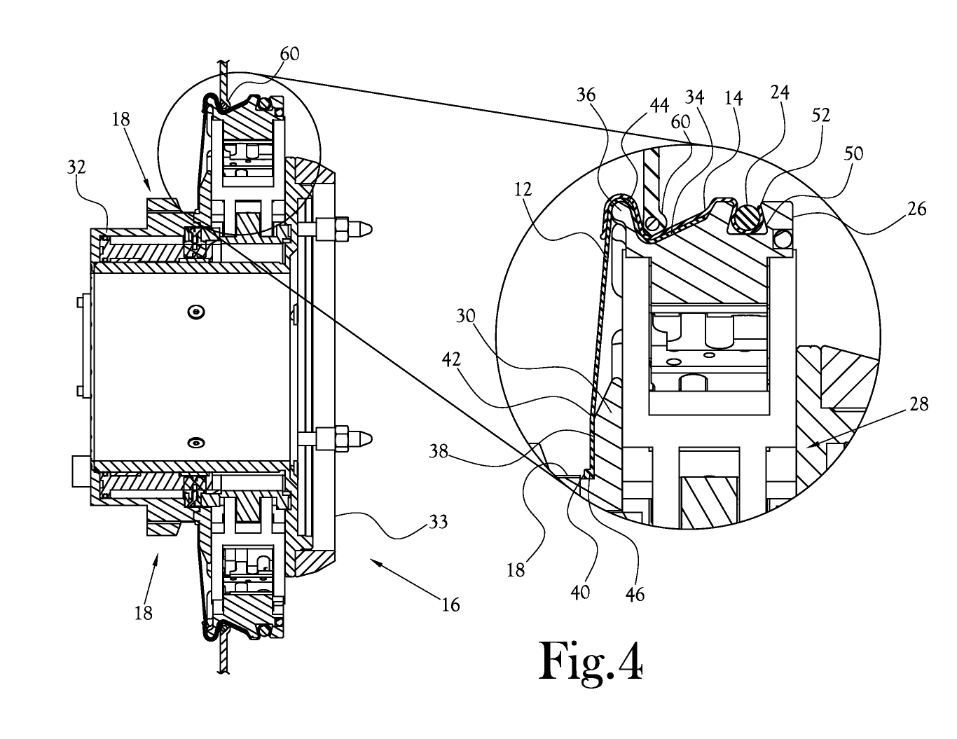

A multi-piece sealing sleeve is disclosed herein and in the accompanying Figures. Referring to FIGS. 1 and 2, the multi-piece sealing sleeve, or sleeve 10, includes a first annular layer 12 and a second annular layer 14 adapted to cooperate to conform generally to outer surfaces of an annular support structure 16 of a tire shaping drum to establish a substantially airtight seal between an interior portion of the support structure 16 and a bead portion 60 of a tire carcass (see FIG. 4) positioned circumferentially along an annular bead seat 20 defined by the support structure 16. As will be further discussed below, at least one fastener 24 is provided to secure at least one of the layers 12, 14 in place along the support structure 16.

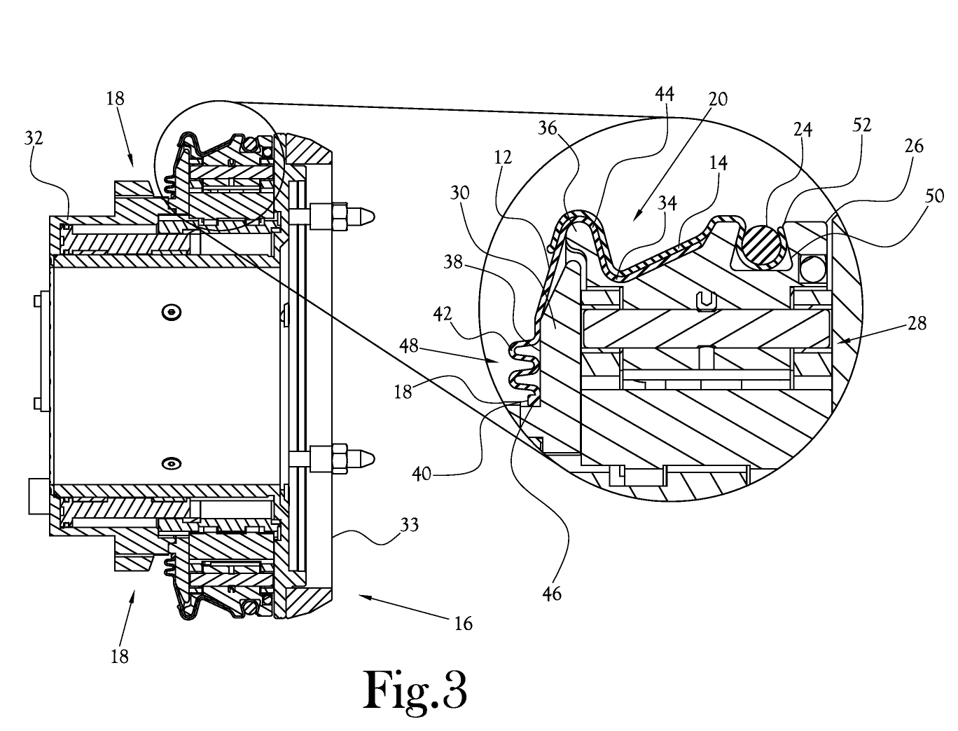

Referring to FIGS. 1 and 3, an annular support structure 16 of a tire shaping drum is illustrated having a generally cylindrical base portion 18 having an inboard end 32 which is adapted to be secured to additional apparatus of the type known in the art to form a complete tire shaping drum, and an outboard end 33 which is adapted to extend generally axially and cantilevered from the inboard end 32 to receive a bead portion 60 of a tire carcass surrounding the outboard end 33. A radially-expandable bead seat 20 is defined by a plurality of radially-extendable segments 26 disposed in a ring configuration about the outboard end 33 of the support structure 16. Each segment 26 is secured to the base portion 18 of the annular support structure 16 by suitable mechanical linkages 28 such that the segments 26 forming the bead seat 20 are radially expandable and contractable between a collapsed position (see FIG. 3) and an expanded position (see FIG. 4). The bead seat 20 defines generally a circumferential annular notch 34 shaped to receive a bead portion 60 of a tire carcass upon axial movement of the segments 26 toward the expanded position and into engagement with the tire carcass bead portion 60. Inboard of the notch 34, the bead seat 20 defines a circumferential sealing flange 36 adapted to abut an interior side of the tire carcass bead portion 60 to encourage sealing engagement of the bead seat 20 with the tire carcass bead portion 60. An annular base flange 30 extends generally radially outwardly from the base portion 18 inboard of the linkages 28 toward the sealing flange 36. In the illustrated embodiment, the base portion 18 and the base flange 30 are secured in a substantially airtight engagement as by, for example, an integral connection.

Referring now to FIGS. 3 and 4, the first layer 12 is defined by an annular, radially extendable and retractable layer of a material which is substantially impermeable to air, such as rubber, polymer, silicon rubber, or other suitable material. The first layer 12 is shaped and configured to extend along an interior surface 38 of the base flange 30 and to overlie at least a portion of the sealing flange 36 such that the first layer 12 provides a substantially airtight seal between the sealing flange 36 and the base flange 30.

As shown in FIG. 3, in the collapsed position of the support structure 16, an inner edge 40 of the first layer 12 is disposed circumferentially along an intersection of the base flange 30 with the base portion 18. In several embodiments, the inner edge 40 is configured to remain in place along the intersection of the base flange 30 with the base portion 18 throughout repositioning of the support structure 16 between the collapsed position (FIG. 3) and the expanded position (FIG. 4). In several embodiments, a seating ring 46 is secured along the inner edge 40. The seating ring 46 is adapted to conform closely to the base portion 32 to hold the inner edge 40 of the first layer 12 in place along the base flange 30 proximate the base portion 32. In certain embodiments, the seating ring 46 is fitted to the annular intersection between the base flange 30 and the base portion 32, and is fabricated to be more resistant to elastic deformation than the remainder of the first layer 12, such that the seating ring 46 retains its shape as the remainder of the first layer 12 is reconfigured between the collapsed position (FIG. 3) and the expanded position (FIG. 4). For example, in the illustrated embodiment, the seating ring 46 is formed having a thicker cross-section than the thickness of the remainder of the first layer 12. In another embodiment (not shown), the seating ring 46 is at least partially formed from a substantially non-elastic material, such as steel cable or other similar material. In yet another embodiment, a circumferential clamp (not shown) is provided to secure the inner edge 40 of the first layer 12 in place along the base flange 30 proximate the base portion 18. Other methods and devices for securing the inner edge 40 of the first layer 12 in place along the base flange 30 proximate the base portion 18 will be readily known to one of ordinary skill in the art.

As mentioned above, an outer section 44 of the first layer 12 is disposed in overlying relation along the sealing flange 36 such that the first layer 12 establishes a substantially airtight barrier between the inboard end 32 of the base portion 18 and the space between the sealing flange 36 and the base flange 30. A central portion 42 of the first layer 12 is capable of radial expansion and contraction in order to allow the first layer 12 to maintain an overlying relation over the base flange 30 and the sealing flange 36, thereby maintaining the airtight seal between the sealing flange 36 and the inboard end 32 of the base portion 18, as the bead seat 20 is expanded and contracted between the contracted position and the expanded position. Referring again to FIGS. 3 and 4, in several embodiments, the central portion 42 is formed of an elastically deformable material, and preferably a resilient deformable material, such as rubber, polymer, silicon rubber, or the like, such that the first annular layer 12 is capable of expanding and contracting to remain generally conforming along the interior surface 38 of the base flange 30 and the surface of the sealing flange 36 as the annular support structure 16 is reconfigured between the collapsed position (FIG. 3) and the expanded position (FIG. 4). In the illustrated embodiment, the first layer central portion 42 defines a series of expandable and collapsible annular folds 48 formed of a resilient deformable material as described above. In this embodiment, the folds 48 allow the central portion 42 to unfold toward a flattened configuration when the support structure 16 is moved toward the expanded position (see FIG. 4) and to return to a folded configuration when the support structure 16 is moved toward the collapsed position (see FIG. 3). In another embodiment, the central portion 42 is configured to stretch and contract such that the central portion 42 maintains a planar configuration along the interior surface 38 of the base flange 30 and the surface of the sealing flange 36 as the support structure 16 is reconfigured between the collapsed position and the expanded position.

The second layer 14 is defined by a generally tubular expandable and contractable sleeve of material which, like the first layer 12, is substantially impermeable to air. The second layer 14 is shaped and configured to overlie and conform closely to at least a portion of the outer section 44 of the first layer 12 to frictionally engage at least a portion of the first layer 12, and also to overlie at least a portion of the radially-extendable segments 26 forming the bead seat 20. In one embodiment, the second layer 14 is defined by a relatively smooth cylindrical tube formed of a resiliently elastic material, such as rubber, polymer, silicon rubber, or the like, and having a diameter slightly less than the diameter of the bead seat 20. In this embodiment, the second layer 14 is adapted to stretch slightly to conform along the surface of the outer section 44 of the first layer 12 and the radially-extendable segments 26 when the support structure 16 is in the collapsed position (see FIG. 3). When the support structure 16 is reconfigured toward the expanded position (see FIG. 4), the second layer 14 is adapted to stretch to maintain conformity along the surface of the outer section 44 of the first layer 12 and the radially-extendable segments 26. In another embodiment, the second layer 14 is defined by a tube-like structure having a contour which conforms to the surface of the outer section 44 of the first layer 12 and the radially-extendable segments 26, absent significant stretching of the second layer 14, when the support structure 16 is in the collapsed position.

Placement of the second layer 14 along the outer section 44 of the first layer 12 and at least a portion of the radially-extendable segments 26 forming the bead seat 20 allows the second layer 14 to establish and maintain a substantially airtight surface along the sealing flange 36 and the bead seat 20 as the support structure 16 is reconfigured between the collapsed position and the expanded position. Referring to FIG. 4, upon placement of a tire carcass bead 60 in surrounding relationship about the bead seat 20 and expansion of the support structure 16 toward the tire carcass bead 60, the second layer 14 expands with the support structure 16 to establish sealing engagement between the tire carcass bead 60 and the bead seat 20. Thus engaged, the first and second layers 12, 14 cooperate to form a substantially airtight seal between the tire carcass bead 60 and the inboard end 32 of the base structure 18.

In certain embodiments, the second layer 14 is fabricated to exhibit anti-adhesive properties along an outer surface thereof, such that the material forming the outer surface of the second layer 14 discourages adhesion of the second layer 14 to the tire carcass bead 60. For example, in several embodiments, the second layer 14 is treated with one or more anti-adhesive materials, such as for example lubricants. In certain embodiments, an outer surface of the second layer 14 is treated with, and in some embodiments incorporates, a powdered dry lubricant, such as for example graphite, molybdenum disulfide, titanium nitride, or the like. In these embodiments, the lubricant along the outer surface of the second layer 14 promotes relatively easy release of the tire carcass bead 60 from contact with the second layer 14 along the bead seat 20 during contraction of the support structure 16 from the tire carcass bead 60, and discourages adhesion of the tire carcass bead 60 to the second layer 14, while simultaneously allowing a substantially airtight seal between the second layer 14 and the tire carcass bead 60 while the support structure 16 is expanded toward the tire carcass bead 60.

In some embodiments, additional dry or wet lubricant may be disposed between the first and second layers 12, 14, and/or between the first layer 12 and the support structure 16, to assist in allowing these components to expand and contract in relation to one another and to discourage excessive wear, non-uniform stretching, tearing, etc., of the layers 12, 14. For example, in some embodiments, a layer of wet lubricant, such as for example grease, oil, or the like, is disposed along exterior surfaces of the first layer 12, between the first layer 12 and the support structure 16, and between the first layer 12 and the second layer 14. In these embodiments, the lubricant assists in allowing the first layer 12 to maintain a substantially even tension about the circumference of the first layer throughout expansion and contraction of the support structure 16. However, it will be understood that inclusion of the lubricant along the first layer 12 is not necessary in every embodiment of the present general inventive concept.

In certain embodiments, at least one fastener 24 is provided to secure at least one of the first and second layers 12, 14 in place along the support structure 16. For example, in the illustrated embodiment of FIGS. 1-4, the support structure 16 defines a circumferential fastener groove 50 outboard from the bead seat 20. The second layer 14 extends along and generally conforms to the contour of the fastener groove 50 and terminates proximate an exterior edge 52 thereof. In the illustrated embodiment, the fastener 24 is defined by an annular band which is sized and configured for placement along the fastener groove 50 in overlying relationship with the portion of the second layer 14 within the fastener groove 50 to secure the second layer 14 proximate the support structure 16. In the illustrated embodiment, the fastener 24 is fabricated from a resilient elastic material, such as rubber, polymer, silicon rubber, or the like, and has an unstretched circumference less than the circumference of the fastener groove 50, such that the fastener 24 may be stretched to fit within the fastener groove 50 and to exert compression along the portion of the second layer 14 disposed within the fastener groove 50, thereby biasing the second layer 14 against the support structure 16. In another embodiment, the fastener 24 is defined by an adjustable non-elastic band, such as an adjustable hose clamp, zip tie, or other such adjustable non-elastic band, which is sized and adapted to be fitted within the fastener groove 50, to apply pressure to the portion of the second layer 14 within the fastener groove 50. In yet another embodiment, the fastener 24 is defined by an annular band of material which is integrally formed with the second layer 14. Those skilled in the art will recognize other devices and apparatus suitable for use in providing the fastener 24, and such devices and apparatus may be used without departing from the spirit and scope of the present invention. Furthermore, those skilled in the art will recognize that inclusion of the fastener 24 is not necessary to accomplish the sleeve 10 of the present invention. To this extent, in one embodiment, each of the first and second layers 12, 14 maintains a frictional connection with respective underlying portions of the support structure 16.

In application and use of the illustrated embodiment of the sleeve 10, it has been found that repeated expansion and contraction of the support structure 16 to engage and form a substantially airtight seal between a tire carcass bead 60 surrounding the bead seat 20 and the inboard end 32 of the base structure 18 typically results in wear of both the first and second layers 12, 14 due, at least in part, to repeated tensioning and compression of the material forming the first and second layers 12, 14. However, it has been found that such repeated use of the sleeve 10 results in more rapid wear of those portions of the sleeve 10 in contact with the tire carcass bead 60, namely, the second layer 14, at least in part due to the friction which occurs between the second layer 14 and the tire carcass bead 60 as the second layer 14 contacts and engages the tire carcass bead 60. The result is that, while both the first and second layers 12, 14 must be periodically replaced, the second layer 14 must be periodically replaced with a frequency approximating the frequency at which a prior art sleeve for a bead shaping drum must be replaced, while the first layer 12 must be replaced much less frequently. Thus, it will be understood that the sleeve 10 incorporating the first and second layers 12, 14 provides several unique advantages over the prior art.

For example, in several embodiments, the various regions and components of the first layer 12 are integrally formed such that the first layer 12 constitutes a unitary member, and likewise, the various regions of the second layer 14 are integrally formed such that the second layer 14 constitutes a unitary member. Referring again to FIGS. 3 and 4, it will be understood that the central portion 42 of the first layer 12 is configured to extend primarily radially outwardly from the base portion 32 along the generally radially-extending interior surface 38 of the base flange 30. Accordingly, it will be understood that, in a typical method of fitting the first layer 12 of the sleeve 10 onto an existing tire shaping drum of the type illustrated, either (1), the first layer 12 is significantly stretched to fit around the outboard end 33 of the support structure 16, including the radially-extendable segments 26, the linkages 28, and the base flange 30, and thereafter allowed to contract to fit the inner edge 40 of the first layer 12 around the intersection of the base flange 30 with the base portion 18, or (2) the support structure 16 is removed from the remainder of the tire shaping drum to allow the first layer 12 to be fitted over the inboard end 32 of the base portion 18 and against the base flange 30. As discussed above with regard to certain prior art sleeve designs, these methods of fitting the first layer 12 onto the support structure 16 are often time consuming and cumbersome and/or hazardous. However, as discussed above, it has been found that the first layer 12 provided in the above-discussed embodiments of the sleeve 10 wears more slowly than, and thus does not need to be replaced as frequently as, various sleeves found in the prior art.

By contrast, in several embodiments, the second layer 14 is configured to extend generally axially along the bead seat 20 defined by the radially-extendable segments 26 of the support structure 16. Thus, in several embodiments, the second layer 14 is more easily replaceable than the first layer 12. For example, in a typical method of fitting the second layer 14 of the sleeve 10 onto an existing tire shaping drum of the type illustrated, the second layer 14 is only slightly stretched to fit the second layer 14 around the outboard end 33 of the support structure 16 and onto the radially-extendable segments 26 when the support structure 16 is in the collapsed position. In certain embodiments, the second layer 14 and the fastener 24 are each is sized, shaped, and composed of material suitable to allow the second layer 14 and the fastener 24 to be fitted around the outboard end 33 of the support structure 16 and onto the radially-extendable segments 26 using finger pressure alone. Accordingly, it will be understood by one of skill in the art that use of the sleeve 10 provides significant reduction in the time, hassle, and hazards associated with replacement of the multi-piece sealing sleeve on a tire shaping drum.

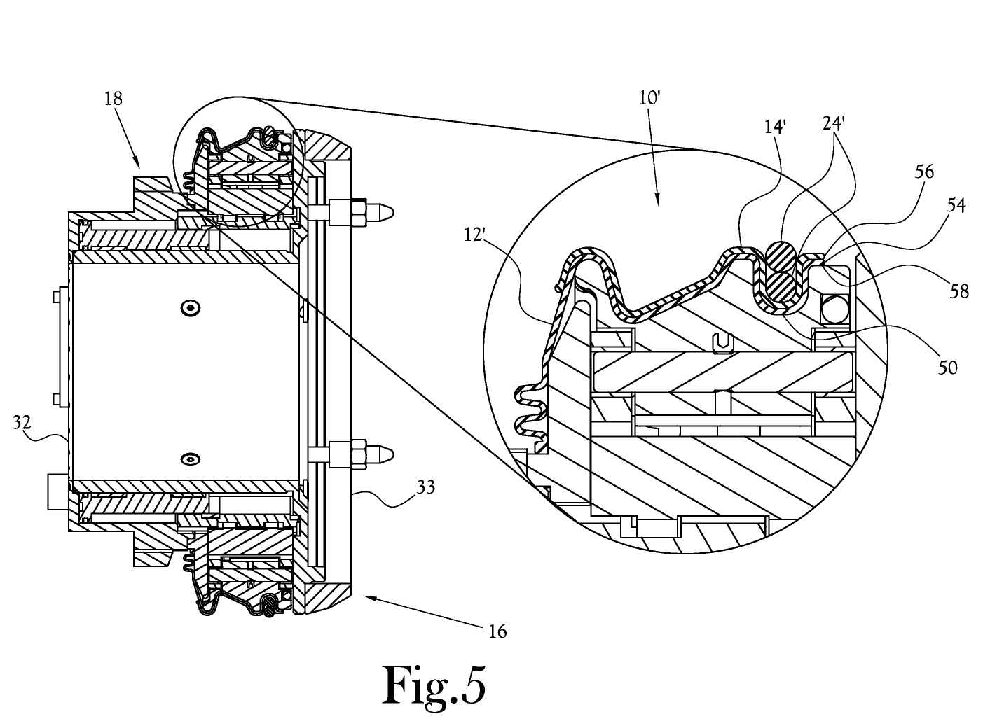

It will be understood that the specific dimensions of the various components of the sleeve may vary, depending at least in part on the need for frictional engagement of the first and second layers with one another and with the surfaces of the support structure 16. For example, FIG. 5 illustrates another embodiment of the sleeve 10′. In the embodiment of FIG. 5, respective exterior edges 54, 56 of the first and second layers 12′,14′ each terminate at a point 58 along the radially-extendable segments 26 outboard of the fastener groove 50. Thus, the entire length of the second layer 14′ overlies a portion of the first layer 12′ and establishes frictional engagement with the first layer 12′ to secure the second layer 14′ in place relative to the first layer 12′. In this embodiment, a plurality of fastener bands 24′ are provided in overlying configuration within the groove 50 to secure both the first and second layers 12′,14′ in place along the support structure 16.

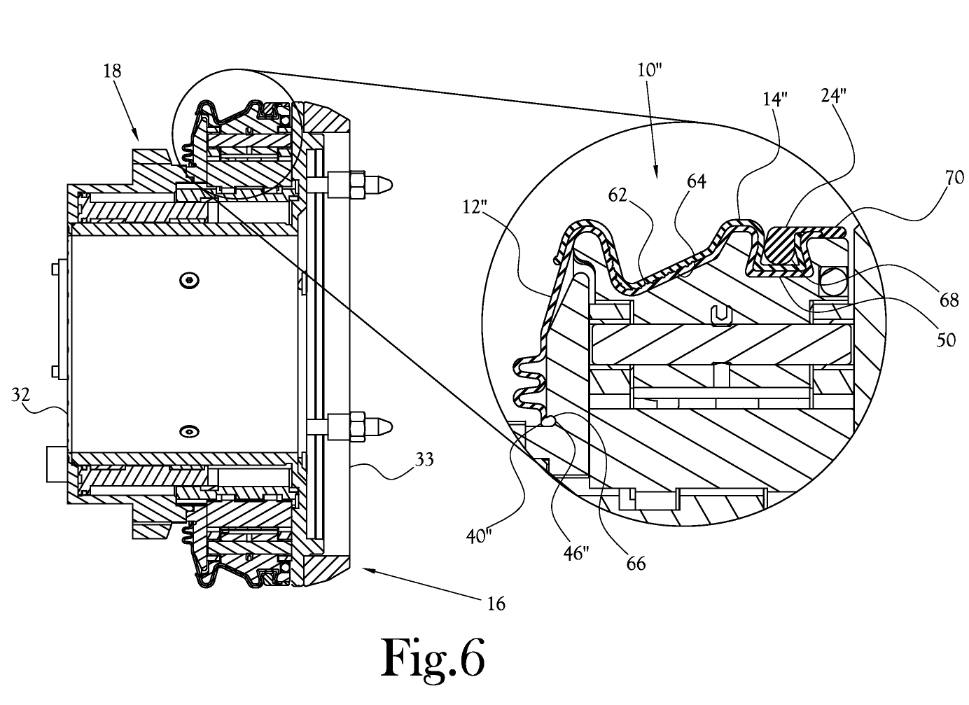

FIG. 6 illustrates another embodiment of the sleeve 10″. In the embodiment of FIG. 6, an interior surface 64 of the second layer 14″ defines a textured surface, such as for example a ribbed, dimpled, or other textured surface. In this embodiment, an exterior surface 62 of the first layer 12″ also defines a textured surface, such that overlying portions of respective textured surfaces 62, 64 of the first and second layers 12″,14″ establish frictional engagement with one another to provide a more secure frictional connection between the first and second layers 12″,14″. In one embodiment, respective textured surfaces 62, 64 of the first and second layers 12″,14″ define complimentary mating surfaces, such that the respective textured surfaces 62, 64 of the first and second layers 12″,14″ are adapted to mate together in overlying relation to one another. However, it will be understood that such mating relationship is not necessary to accomplish the sleeve 10″ of the present invention.

In certain embodiments, the lower edge 40 of the first layer is adapted to establish locking engagement with the support structure 16 along an interface between the base portion 18 and the base flange 30. For example, as shown in FIG. 6, in one embodiment, the lower edge 40″ of the first layer 12″ defines an annular, generally outboard-extending seating ring 46″ which is secured along the first layer lower edge 40″ by a suitable connection, such as for example an integral connection. A corresponding annular seating groove 66 is defined along an interface between the base portion 18 and the base flange 30. The seating ring 46″ is adapted to be received within the seating groove 66 to establish frictional locking engagement between the lower edge 40″ of the first layer 12″ and the support structure 16.

It will be understood that, in certain embodiments in which portions of the layers 12, 14 are secured beneath a fastener 24 defining an elastic, generally toroidal member, excessive tensioning of the layers 12, 14 along planar dimensions thereof can, in some circumstances, result in rolling of the fastener 24 about a rotational axis of the torus, thereby allowing slippage of the portions of the layers 12, 14 along the support structure 16 and out from beneath the fastener 24. Such rolling of the fastener 24 can result, in some circumstances, in failure of the fastener 24 to maintain the layers 12, 14 in secure engagement along the fastener groove 50. Accordingly, in certain embodiments, the fastener 24″ defines a shape which is adapted to discourage rolling of the fastener 24″. For example, in the embodiment of FIG. 6, the fastener 24″ defines an annular ring portion 68 sized to fit within and along the fastener groove 50 as described above, and an annular, radially-projecting lip 70 which extends outwardly from the fastener groove 50 along a circumference of the fastener 24″. The lip 70 is adapted to abut a portion of the support structure 16 outboard from the fastener groove 50 to discourage rolling of the fastener 24″ within the fastener groove 50, thereby maintaining a more secure, locking relationship between the fastener 24″ and the support structure 16.

From the foregoing description, it will be recognized by those skilled in the art that an improved sealing sleeve for a tire shaping drum has been provided. While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

Having thus described the aforementioned invention, what is claimed is:

1. A tire building drum useful in the manufacture of vehicle tires, said tire building drum comprising:
an annular, radially expandable and collapsible structure defining a circumferential bead seat and a circumferential groove located axially adjacent the bead seat;
an annular base portion axially and radially inward of said structure;
an annular first layer of substantially air-impermeable material having an inner circumferential edge conforming to said base portion, said first layer extending radially and axially outward to overlie and conform to an axially outer edge of said bead seat;
an annular second layer of substantially air-impermeable material extending along an axially inner edge of said bead seat and axially outward to overlie and conform to said bead seat and said circumferential groove; and
a fastener for securing said second layer along said structure, said fastener defined by at least one annular band received within said circumferential groove and overlying said second layer;
whereby when a tire bead is received along said bead seat, said second layer is interposed between said first layer and the tire bead to establish a substantially airtight seal between said first layer and the tire bead and to protect said first layer from wear by the tire bead, and whereby said first layer establishes a substantially airtight seal between said base portion and said second layer.

2. The tire building drum of claim 1, said structure defining a circumferential flange extending along an axially inward edge of said bead seat, said second layer having an axially inner edge overlying said flange.

3. The tire building drum of claim 2, said band circumferentially surrounding and exerting compression along at least a portion of said second layer.

4. The tire building drum of claim 3, said at least one annular band being fabricated from a resilient elastic material.

5. The tire building drum of claim 4, said fastener further including an annular lip extending along a circumference of said band.

6. The tire building drum of claim 5, said lip extending along said support structure outboard from said groove to discourage rolling of said band within said groove.

7. The tire building drum of claim 6, each of said first and second layers extending axially outwardly to overlie and conform to said circumferential groove, said band overlying said first and second layers within said groove to secure said first and second layers along said structure.

8. The tire building drum of claim 1, said first layer being radially expandable and collapsible to allow said first layer to maintain a substantially airtight seal between said base portion and said second layer during expansion and contraction of said structure.

9. The tire building drum of claim 8, said first layer being fabricated from a resilient elastic material.

10. The tire building drum of claim 8, said first layer defining a plurality of annular folds adapted to unfold toward a flattened configuration and to return to a folded configuration to allow the first layer to radially expand and contract.

11. The tire building drum of claim 10, further including a seating ring integrally formed along said first layer inner edge, said seating ring being adapted to hold said first layer inner edge in conformity along said base portion.

12. The tire building drum of claim 11, said seating ring having a thicker cross-section than a thickness of said first layer.

13. The tire building drum of claim 12, said base portion defining an annular seating groove extending along a circumference thereof, said seating ring being received within said seating groove.

14. The tire building drum of claim 1, said second layer having an inner surface defining a texture.

15. The tire building drum of claim 1, said first layer having an outer surface defining a texture.

16. The tire building drum of claim 15, said second layer having an inner surface defining a complimentary mating texture to said first layer outer surface.

17. The tire building drum of claim 1, said second layer having an outer surface incorporating an anti-adhesion material.

18. The tire building drum of claim 17, said second layer being fabricated from a material selected from the group consisting of rubber, polymer, and silicon rubber.

19. The tire building drum of claim 18, said second layer outer surface further incorporating a dry lubricant.

20. The tire building drum of claim 18, said second layer outer surface further incorporating a powder comprising molybdenum disulfide.
